(19) United States
(12) Patent Application Publication
(10) Pub. No.: US 2025/0147638 A1
(43) Pub. Date: May 8, 2025

(54) ELECTRONIC DEVICE AND CONTROLLING METHOD THEREOF

(71) Applicant: SAMSUNG ELECTRONICS CO., LTD., Suwon-si (KR)

(72) Inventors: Jaesung PARK, Suwon-si (KR); Younghoon JEONG, Suwon-si (KR)

(73) Assignee: SAMSUNG ELECTRONICS CO., LTD., Suwon-si (KR)

(21) Appl. No.: 19/018,767

(22) Filed: Jan. 13, 2025

Related U.S. Application Data
(63) Continuation of application No. PCT/KR2023/009416, filed on Jul. 4, 2023.

(30) Foreign Application Priority Data
Aug. 25, 2022 (KR) 10-2022-0107119

(51) Int. Cl. G06F 3/0482; G06F 3/04817; G06F 3/16

(52) U.S. Cl. CPC G06F 3/0482; G06F 3/04817; G06F 3/165

(57) ABSTRACT

An electronic device includes a display; a speaker; one or more processors; and memory storing instructions that, when executed by the one or more processors, cause the electronic device to, based on an initial setting mode being initiated, control the display to display a first user interface (UI) for guiding a user as to a first initial setting mode for disability assistance; control the speaker to output a first guide voice corresponding to the first UI; based on the first initial setting mode for disability assistance being selected through the first UI, control at least one of the display or the speaker to provide a first accessibility menu including accessibility functions corresponding to a disability type of the user; and based on at least one accessibility function being selected from the first accessibility menu, control the display or the speaker based on the at least one accessibility function.

### CROSS-REFERENCE TO RELATED APPLICATIONS

This application is a by-pass continuation application of International Application No. PCT/KR2023/009416, filed on Jul. 4, 2023, which is based on and claims priority to Korean Patent Application No. 10-2022-0107119, filed on Aug. 25, 2022, in the Korean Intellectual Property Office, the disclosures of which are incorporated by reference herein in their entireties.

### BACKGROUND

### 1. Field

The present disclosure relates to an electronic device and a controlling method thereof, and more particularly to, an electronic device that provides an initial setting mode for assisting a user with disability an accessibility menu and a controlling method thereof.

### 2. Description of Related Art

When a user first installs and starts a display device such as a TV or a computer, the user goes through an overall initial setup process for the language, screen, sound, network, etc. that will be output to the display device.

If the user has a physical disability such as visual impairment (e.g., color blindness, astigmatism, blindness, etc.) or hearing impairment, the initial setup process is more challenging than for users without physical disabilities because the display device is not equipped with visual and auditory assistance functions tailored to the user's disability when it is first installed and started.

Therefore, there is a need to assist users with physical disabilities in the initial setup process when installing and starting a display device such as a TV or a computer for the first time, so that the initial setup process can be smoother for the users with physical disabilities.

Here, ways to guide and assist users with physical disabilities to proceed with the initial setup of the display device are requested.

### SUMMARY

According to an aspect of the disclosure, an electronic device includes a display; a speaker; one or more processors; and memory storing instructions that, when executed by the one or more processors, cause the electronic device to, based on an initial setting mode being initiated, control the display to display a first user interface (UI) for guiding a user as to a first initial setting mode for disability assistance; control the speaker to output a first guide voice corresponding to the first UI; based on the first initial setting mode for disability assistance being selected through the first UI, control at least one of the display or the speaker to provide a first accessibility menu including a plurality of accessibility functions corresponding to a disability type of the user; and based on at least one accessibility function being selected from the first accessibility menu, control at least one of the display or the speaker based on the at least one accessibility function.

The one or more processors may be configured to execute the instructions to cause the electronic device to, based on the first initial setting mode for disability assistance being selected, control the display to display a second UI for identifying the disability type of the user; control the speaker to output a second guide voice corresponding to the second UI; and based on the disability type of the user being identified, control at least one of the display or the speaker to provide a second menu for a second accessibility function corresponding to the disability type of the user.

The second UI may include a question for identifying the disability type of the user.

The one or more processors may be configured to execute the instructions to cause the electronic device to, based on the first initial setting mode for disability assistance being selected, control the display to display a third UI corresponding to a third accessibility menu including the plurality of accessibility functions; and based on the disability type of the user being identified as a visual impairment, control the display to display a fourth UI including a third menu for at least one third accessibility function corresponding to the visual impairment from among the plurality of accessibility functions separately from the third UI.

The one or more processors may be configured to execute the instructions to cause the electronic device to, based on the disability type of the user being identified as a visual impairment, control at least one of the display or the speaker to provide a third menu for a third accessibility function including at least one of a high-contrast output function, an outline emphasis function, or a color inversion output function.

The one or more processors may be configured to execute the instructions to cause the electronic device to, based on at least one menu for the at least one accessibility function being selected, control the display to output a screen to which the selected at least one accessibility function is applied.

The one or more processors may be configured to execute the instructions to cause the electronic device to, based on the disability type of the user being identified as a hearing impairment, control at least one of the display or the speaker to provide a third menu for a third accessibility function including at least one of a sign language function or a frequency band amplification function.

The one or more processors may be configured to execute the instructions to cause the electronic device to, based on the first initial setting mode for disability assistance being selected, control the display to display a GUI corresponding to a remote controller based on a visual GUI corresponding to a visual impairment; control the display to display usage information for at least one button included in the remote controller; and control the speaker to output a second guide voice corresponding to the usage information.

The electronic device may further include a communication interface, and the one or more processors may be configured to execute the instructions to cause the electronic device to, while an application corresponding to the first initial setting mode is executed in an external user terminal, based on a received signal corresponding to a user command received through an execution screen of the application being obtained, control a selection of a second menu provided in the first initial setting mode based on the received signal.

According to an aspect of the disclosure, a control method of an electronic device includes, based on an initial setting mode being initiated, displaying a first user interface (UI) for guiding a user as to a first initial setting mode for disability assistance; outputting a first guide voice corresponding to the first UI; based on the first initial setting mode for disability assistance being selected through the first UI, providing a first accessibility menu including a plurality of accessibility functions corresponding to a disability type of the user; and based on at least one accessibility function being selected from the first accessibility menu, controlling the electronic device based on the at least one accessibility function.

The providing the first accessibility menu may include, based on the first initial setting mode for disability assistance being selected, displaying a second UI for identifying the disability type of the user; outputting a second guide voice corresponding to the second UI; and based on the disability type of the user being identified, providing a second menu for a second accessibility function corresponding to the disability type of the user.

The second UI may include a question for identifying the disability type of the user.

The providing the first accessibility menu may include, based on the first initial setting mode for disability assistance being selected, displaying a third UI corresponding to a third accessibility menu including the plurality of accessibility functions; and based on the disability type of the user being identified as visual impairment, displaying a fourth UI including a third menu for at least one second accessibility function corresponding to the visual impairment from among the plurality of accessibility functions separately from the third UI.

The providing the first accessibility menu may include, based on the disability type of the user being identified as a visual impairment, providing a third menu for a third accessibility function including at least one of a high-contrast output function, an outline emphasis function, or a color inversion output function.

The providing the first accessibility may include, based on at least one menu for the at least one accessibility function being selected, outputting a screen to which the selected at least one accessibility function is applied.

The providing the first accessibility menu may include, based on the disability type of the user being identified as a hearing impairment, providing a third menu for a third accessibility function including at least one of a sign language function or a frequency band amplification function.

The control method further may include, based on the first initial setting mode for disability assistance being selected, displaying a GUI corresponding to a remote controller based on a visual GUI corresponding to a visual impairment, displaying usage information for at least one button included in the remote controller, and outputting a second guide voice corresponding to the usage information.

The electronic device may further include a communication interface, and the control method may further include, while an application corresponding to the first initial setting mode is executed in an external user terminal, based on a received signal corresponding to a user command received through an execution screen of the application being obtained, controlling a selection of a second menu provided in the first initial setting mode based on the received signal.

According to an aspect of the disclosure, a non-transitory computer-readable recording medium having instructions recorded thereon, that, when executed by one or more processors, may cause the one or more processors to, based on an initial setting mode being initiated, displaying a first UI that guides a first initial setting mode for disability assistance; outputting a guide voice corresponding to the first UI; based on the first initial setting mode for disability assistance being selected through the first UI, providing an accessibility menu including a plurality of accessibility functions corresponding to a disability type of a user; and based on at least one accessibility function being selected from the accessibility menu, controlling the electronic device based on the at least one accessibility function.

### DESCRIPTION OF THE DRAWINGS

The aspects, features and advantages of embodiments of the present disclosure will become more apparent through the following description with reference to the accompanying drawings.

FIG. 1 is a view provided to explain an electronic device according to an embodiment;

FIGS. 2A and 2B are block diagrams provided to explain configuration of an electronic device according to an embodiment;

FIG. 3A is a view provided to explain an initial setting mode of an electronic device according to an embodiment;

FIG. 3B is a view provided to explain initial setting mode guidance for disability assistance of an electronic device according to an embodiment;

FIG. 3C is a view provided to explain usage information guidance of remote control buttons provided in an initial setting mode for disability assistance of an electronic device according to an embodiment;

FIG. 3D is a view provided to explain a screen that provides usage information for remote control buttons provided in an initial setting mode for disability assistance of an electronic device according to an embodiment;

FIG. 4 is a view provided to explain an accessibility menu including a plurality of accessibility functions for disability assistance displayed by an electronic device according to an embodiment;

FIG. 5 is a view provided to explain an accessibility menu including a plurality of accessibility functions for disability assistance displayed by an electronic device according to an embodiment;

FIG. 6A is a view provided to explain a screen displayed by an electronic device

according to an embodiment;

FIG. 6B is a view provided to explain a screen to which a high-contrast output function from among a plurality of accessibility functions is applied according to an embodiment;

FIG. 6C is a view provided to explain a screen to which an outline emphasis function from among a plurality of accessibility functions is applied according to an embodiment;

FIG. 6D is a view provided to explain a screen to which a color inversion output function from among a plurality of accessibility functions is applied according to an embodiment;

FIG. 7A is a view provided to explain a screen to which a sign language function from among a plurality of accessibility functions is applied according to an embodiment;

FIG. 7B is a view provided to explain a frequency band amplification function from among a plurality of accessibility functions is applied according to an embodiment;

FIG. 8 is a view provided to explain a GUI for describing usage information for buttons included in a remote controller according to another embodiment;

FIG. 9 is a view provided to explain an operation of controlling a selection of a menu provided in an initial setting mode based on a signal corresponding to a user command received through an external user terminal device according to an embodiment; and

FIG. 10 is a flowchart provided to explain an operation of an electronic device according to an embodiment.

### DETAILED DESCRIPTION

The embodiments of the present disclosure may be modified in various ways, and may have various embodiments, so embodiments are illustrated in the drawings and described in detail in the detailed description. However, it is to be understood that the disclosure is not limited to exemplary embodiments, but include all modifications, equivalents, and/or alternatives according to exemplary embodiments of the disclosure. Throughout the description of the accompanying drawings, similar components may be denoted by similar reference numerals.

In addition, the following exemplary embodiments may be modified in several different forms, and the scope of the technical spirit of the disclosure is not limited to the following exemplary embodiments. Rather, these exemplary embodiments make the disclosure thorough and complete, and are provided to completely transfer the spirit of the disclosure to those skilled in the art.

Terms used in the disclosure are used to describe exemplary embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In exemplary embodiments, a ‘module’ or a ‘˜er’ may perform at least one function or operation, and be implemented as hardware or software or be implemented as a combination of hardware and software. In addition, a plurality of ‘modules’ or a plurality of ‘˜er’ may be integrated into at least one module and the functionality may be performed by at least one processor except for a ‘module’ or a ‘˜er’ to be implemented as hardware.

Various elements and regions in the drawings are schematically drawn in the drawings. Therefore, the technical concept of the disclosure is not limited by a relative size or spacing drawn in the accompanying drawings.

Hereinafter, an embodiment according to the present disclosure will be described in detail with reference to the accompanying drawings so that a person with ordinary knowledge in the technical field to which the present disclosure belongs can implement the present disclosure.

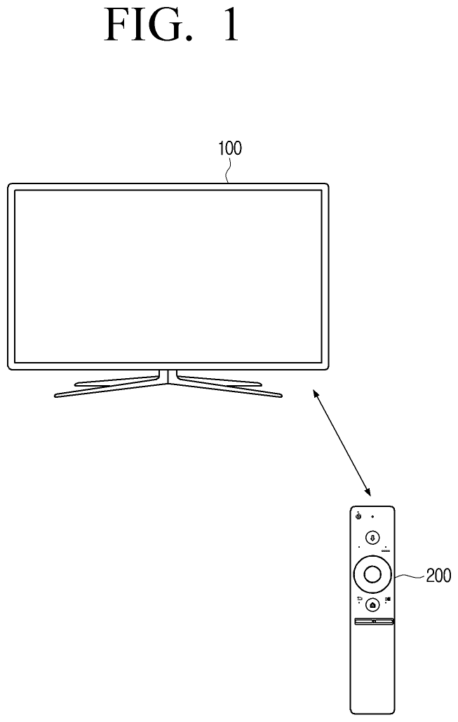

FIG. 1 is a view provided to explain an electronic device according to an embodiment.

Referring to FIG. 1, an electronic device 100 may be an electronic device 100 having a display such as a television. However, the electronic device 100 is not limited thereto, and the electronic device 100 may be implemented as any device having a display capable of playing video content, such as smart TV, tablet, monitor, smartphone, desktop computer, laptop computer, or the like.

The electronic device 100 may perform a communication connection with a user terminal device 200 such as a remote controller through a wired/wireless communication interface to transmit/receive control signals. Here, the user terminal device 200 is not limited to a remote controller, but may be various devices such as wearable device, smartphone, or the like, which may transmit signals for controlling the electronic device 100 based on a user input to the electronic device 100 through the wired/wireless communication interface.

The electronic device 100 may perform a communication connection with the user terminal device 200 such as a remote controller through a wired or wireless communication interface, and when paired, may control the display to display a UI corresponding to the remote controller by identifying the ID of the user terminal device 200.

Here, information about the GUI corresponding to the remote controller may be information received by the electronic device 100 from an external server through a communication interface or information stored in the memory of the electronic device 100.

The user terminal device may transmit signals for controlling the electronic device 100 based on a user input to the electronic device 100 through a wired or wireless communication interface, and the electronic device 100 may perform various operations such as outputting video or audio content based on the control signals received from the user terminal device.

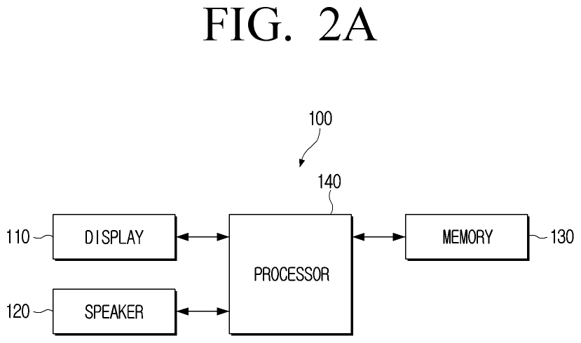

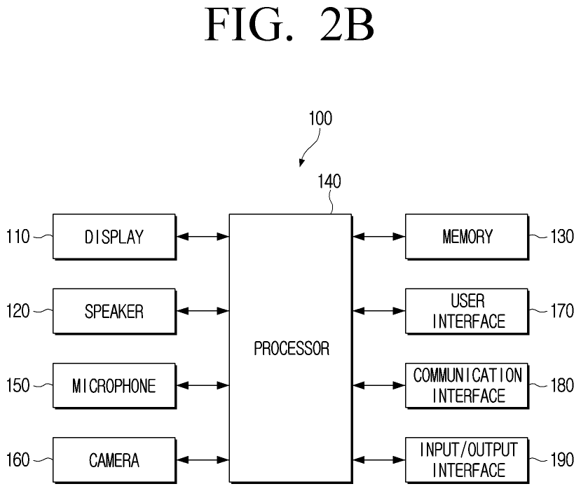

FIGS. 2A and 2B are block diagrams provided to explain configuration of the electronic device 100 according to an embodiment.

Referring to FIG. 2A, the electronic device 100 may include a display 110, a speaker 120, memory 130, and one or more processors 140.

The display 110 may include various types of display panels such as liquid crystal display (LCD) panels, organic light emitting diodes (OLED) panels, active-matrix organic light-emitting diodes (AM-OLED), liquid crystal on silicon (LcoS), quantum dot light-emitting diodes (QLED), and digital light processing (DLP), plasma display panel (PDP) panels, inorganic LED panels, and micro-LED panels, and the like, but the display 110 is not limited thereto. The display 110 may also be configured as a touchscreen with a touch panel, or may be configured as a flexible panel.

The display 110 may be implemented in the form of a 2D square or rectangle, but is not limited thereto, and may be implemented in various shapes such as circular, polygonal, 3D stereoscopic shapes, etc.

The one or more processors (hereinafter, referred to as processors) 140 may control the display 110 to output various entertainment content and guidance content that can be visually provided to a user, such as video content, images, content, a UI to guide the user through an initial setting mode, a UI to identify the user's disability type, a UI corresponding to an accessibility menu that includes a plurality of accessibility functions for disability assistance, etc.

The speaker 120 may consist of a tweeter for reproducing high-pitched sound, a midrange for reproducing midrange sound, a woofer for reproducing low-pitched sound, a subwoofer for reproducing extremely low-pitched sound, an enclosure for controlling resonance, a crossover network for dividing the frequency of an electrical signal input to the speaker 120 into bands.

The speaker 120 may output an acoustic signal to the outside of the electronic device 100. The speaker 120 may output multimedia playback, recording playback, various notification sounds, voice messages, etc. The electronic device 100 may include an audio output device such as the speaker 120, but may also include an output device such as an audio output terminal. The speaker 120 may provide acquired information, information processed or produced based on the acquired information, response results to a user's voice, operation results, etc. in the form of a voice.

The processor 140 may control the speaker 120 to output a voice corresponding to video content, a voice guiding an initial setting mode (or a voice corresponding to a UI guiding the initial setting mode), a voice corresponding to an accessibility menu including accessibility functions for disability assistance (or a voice corresponding to a UI including the accessibility menu), a voice for identifying the disability type of the user (or a voice corresponding to a UI for identifying the disability type of the user), a voice regarding a question for identifying the disability type of the user, a voice regarding usage information for a remote controller (or a voice corresponding to a visual GUI including usage information for the remote controller), and the like.

The memory 130 stores various programs or data temporarily or non-temporarily, and transmits the stored information to the processor 140 according to the call of the processor 140. The memory 130 may also store various information for the calculation, processing or control operation of the processor 140 in an electronic form.

The memory 130 may include at least one of, for example, a main memory or an auxiliary memory. The main memory may be implemented using a semiconductor storage medium such as ROM and/or RAM. The ROM may include, for example, conventional ROM, EPROM, EEPROM, and/or MASK-ROM. The RAM may include, for example, DRAM and/or SRAM. The auxiliary memory may be implemented using at least one storage medium capable of permanently or semi-permanently storing data, such as a flash memory 130 device, a secure digital (SD) card, a solid state drive (SSD), a hard disk drive (HDD), a magnetic drum, optical media such as a compact disc (CD), a DVD, or a laser disc, magnetic tape, a photomagnetic disk, and/or a floppy disk.

The memory 130 may store information about an initial setting mode, information about accessibility functions corresponding to the disability type for disability assistance (e.g., high-contrast output function, outline emphasis function, color inversion function, sign language function, frequency band amplification function), information about a menu including accessibility functions, information about a question for identifying the disability type of the user, information about the disability type of the user, information about usage of buttons included in the remote controller, information about video content, audio information, and information about various UIs displayed on the display 110.

The processor 140 controls the overall operations of the electronic device 100. The processor 140 may be associated with the configuration of the electronic device 100 including the memory 130 as described above, and may control the overall operations of the electronic device 100 by executing at least one instruction stored in the memory 130 as described above. The processor 140 may be implemented as a plurality of processors as well as a single processor.

The processor 140 may be implemented in various ways. For example, the processor 140 may be implemented as at least one of an Application Specific Integrated Circuit (ASIC), an embedded processor, a microprocessor, hardware control logic, a hardware Finite State Machine (FSM), or a Digital Signal Processor (DSP).

The processor 140 in the present disclosure include one or more of a central processing unit (CPU), a micro controller unit (MCU), a micro processing unit (MPU), a controller, an application processor (AP) or a communication processor (CP), and an ARM processor, or may be defined as the corresponding term. In addition, the processor 140 may be implemented as a system on chip (SoC) with embedded processing algorithms, a large scale integration (LSI), or in the form of a field programmable gate array (FPGA). The processor may perform various functions by executing computer executable instructions stored in the memory 130. Further, the processor 140 may include at least one of a graphics-processing unit (GPU), a Neural Processing Unit (NPU) or a Visual Processing Unit (VPU) which are separate AI-dedicated processors 140.

The processor 140 may control the display 110 to display image content, video content, and various UIs, and may control the speaker 120 to output audio content.

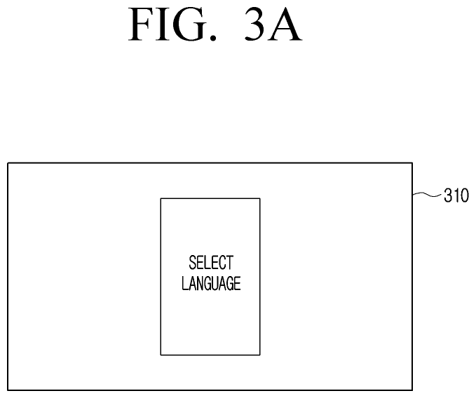

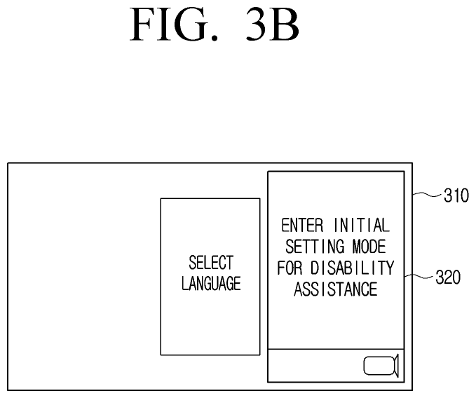

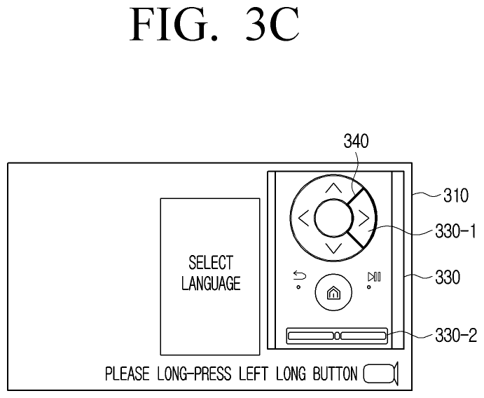

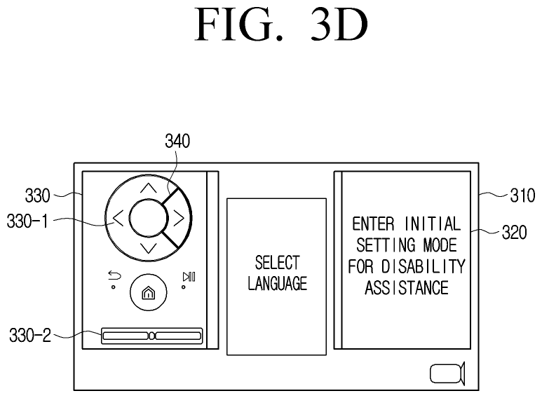

Operations of the processor 140 to control the electronic device 100 will be described later with reference to FIGS. 3 to 9.

The electronic device 100 is not limited to the configurations described above, and referring to FIG. 2B, the electronic device 100 may further include a microphone 150, a camera 160, a user interface 170, a communication interface 180, and an input/output interface 190.

The microphone 150 may refer to a module that acquires sound and converts it into an electrical signal, and may be condenser microphone, ribbon microphone, moving coil microphone, piezoelectric element microphone, carbon microphone, or micro electro mechanical system (MEMS) microphone. The microphone 150 may also be implemented in an omnidirectional, bidirectional, unidirectional, sub-cardioid, super-cardioid, or hyper-cardioid manner.

The processor 140 may acquire information about a obtained through the microphone 150. The microphone 150 may detect a user's voice command, and the processor 140 may acquire information about the user's voice command detected through the microphone 150. Based on the information about the acquired user voice command, the processor 140 may perform an operation to control the display 110, the speaker 120, the communication interface 180, and the like.

The camera 160 may capture images, still images, and moving images around the electronic device 100 or of a user located around the electronic device 100. According to an embodiment, the camera 160 module may include one or more lenses, an image sensor, an image signal processor 140, or a flash.

The processor 140 of the electronic device 100 may obtain information about images, still images, and moving images acquired through the camera 160.

The camera 160 may photograph the surroundings of the electronic device 100 or a user around the electronic device 100, and the processor 140 may acquire information about the image or video of the surroundings of the electronic device 100 or a user located around the electronic device 100 photographed through the camera 160. Based on the acquired information about the image or video of the surroundings of the electronic device 100 or a user located around the electronic device 100, the processor 140 may perform operations such as turning on/off the electronic device 100, controlling the screen output through controlling the display 110, controlling the sound through controlling the speaker 120, etc. For example, when it is identified that a user is located within a preset distance from the electronic device 100 based on an image acquired through the camera 160, the processor 140 may turn on the electronic device 100, control the screen brightness of the display 110, control the volume of the sound, or the like,.

The user interface 170 may include button, lever, switch, sensor-type or touch-type interface, or the like, and the touch-type interface may be implemented in such a way that it receives a user's touch as an input on the screen of the display 110.

The processor 140 of the electronic device 100 may receive a user input through the user interface 170. The processor 140 may receive a user input through the user interface 170 and control the display 110 to output video content, various UIs, or control the speaker 120 to output a voice.

The processor 140 may receive a user input to select an initial setting mode for disability assistance through the user interface 170, and control the display 110 or the speaker 120 to provide an accessibility menu including a plurality of accessibility functions corresponding to the user's disability type.

The processor 140 may receive a user input to select an accessibility function through the user interface 170, and control the display 110 or the speaker 120 based on the selected accessibility function.

The processor 140 may receive a user input to select the user's disability type or a user input to select an answer to a question to identify the user's disability type through the user interface 170.

The communication interface 180 may include a wireless communication interface, a wired communication interface, or an input interface. The wireless communication interface may perform communication with various external devices using wireless communication technologies or mobile communication technologies. Such wireless communication technologies include, for example, Bluetooth, Bluetooth Low Energy, CAN communication, Wi-Fi, Wi-Fi Direct, ultrawide band (UWB), and Zigbee, Infrared Data Association (IrDA), Near Field Communication (NFC), etc. and the mobile communication technologies may include 3GPP, Wi-Max, Long Term Evolution (LTE), 5G, etc.

The wireless communication interface may be implemented using antennas, communication chips, substrates, etc. capable of transmitting electromagnetic waves to the outside or receiving electromagnetic waves transmitted from the outside.

The wired communication interface may perform communication with various external devices based on a wired communication network. Here, the wired communication network may be implemented using physical cables such as, for example, pair cables, coaxial cables, fiber optic cables, or Ethernet cables.

One of the wireless communication interface or the wired communication interface may be omitted depending on the embodiment. Accordingly, the electronic device 100 may include only the wireless communication interface or only the wired communication interface. In addition, the electronic device 100 may include an integrated communication interface that supports both wireless access through the wireless communication interface and wired access through the wired communication interface.

The electronic device 100 is not limited to a case including one communication interface 180 that performs a communication connection in one way, but may include a plurality of communication interfaces 180 that perform a communication connection in a plurality of ways.

The processor 140 according to various embodiments of the present disclosure may perform communication with various external electronic devices 100 or servers located outdoors or indoors through the communication interface 180.

The processor 140 may perform a communication connection with a user terminal device or an external device, such as a remote controller, a smartphone, a wearable device, or the like, through the communication interface 180 to transmit/receive a signal regarding control of the electronic device 100. Here, the signal regarding the control of the electronic device 100 may be a signal to select a UI displayed on the display 110 of the electronic device 100, a signal to turn on/off the electronic device 100, or various other signals to control the operations of the electronic device 100.

The input/output interface 190 may be provided to be connectable to another device separately provided from the electronic device 100, for example, an external storage device. For example, the input/output interface 190 may be a universal serial system bus (USB) terminal, or may be one of High Definition Multimedia Interface (HDM), Mobile High-Definition Link (MHL), Universal Serial Bus (USB), Display Port (DP), Thunderbolt, Video Graphics Array (VGA) port, RGB port, D-subminiature (D-SUB), or Digital Visual Interface (DVI).

The input/output interface 190 may input/output at least one of audio or video signals. Depending on an implementation example, the input/output interface 190 may include a port that inputs/outputs only audio signals and a port that inputs/outputs only video signals as separate ports, or may be implemented as a single port that inputs/outputs both audio and video signals.

The processor 140 of the electronic device 100 may be connected to an external device through the input/output interface 190 to transmit/receive signals regarding control of the electronic device 100. The processor 140 may be connected to an external device through the input/output interface 190 to transmit/receive signals regarding control of the display 110, the speaker 120, etc.

As described above, the electronic device 100 may include various configurations, and may further include various configurations for controlling the operations of the electronic device 100 without being limited to the device configurations described above, or may not include some of the configurations.

According to an embodiment of the electronic device 100 described above, when an initial setting mode is initiated, the processor 140 may control the display 110 to display a first UI that guides the initial setting mode for disability assistance.

The processor 140 may control the speaker 120 to output a guide voice corresponding to the first UI.

When the initial setting mode for disability assistance is selected through the first UI, the processor 140 may control at least one of the display 110 or the speaker 120 to provide an accessibility menu including a plurality of accessibility functions corresponding to the user's disability type.

When at least one accessibility function is selected from the accessibility menu, the processor 140 may control at least one of the display 110 or the speaker 120 based on the at least one accessibility function.

Hereinafter, a method of providing an initial setting mode and an accessibility menu for disability assistance, which is an object of the present disclosure, will be described with reference to FIGS. 3 to 9.

FIG. 3A is a view provided to explain an initial setting mode of the electronic device 100 according to an embodiment.

Referring to FIG. 3A, when the initial setting mode is initiated, the processor 140 may control the display 110 to output a screen 310 regarding the initial setting mode, including a screen for selecting a language. Here, the initial setting mode may be an out of box (OOB) mode in which a user sets up various functions of the electronic device 100 after purchasing the electronic device 100.

FIG. 3B is a view provided to explain initial setting mode guidance for disability assistance of the electronic device 100 according to an embodiment.

Referring to FIG. 3B, when the initial setting mode is initiated, the processor 140 may control the display 110 to display a first UI 320 in a first area of the screen 310 regarding the initial setting mode that guides the initial setting mode for disability assistance.

The initial setting mode for disability assistance may provide various information to guide a user with a disability, such as a visually impaired user, to enter an accessibility menu for initial setting of the electronic device 100. For example, the initial setting mode for disability assistance may provide information such as how to use buttons of a remote controller. Accordingly, a visually impaired user may enter the accessibility menu.

The processor 140 may control the display 110 to display the first UI 320 in various shapes and colors, including, but not limited to, a rectangular shape, a square shape, and so forth.

The processor 140 may display the first UI 320 and the information about “entering the initial setting mode for disability assistance” together. The processor 140 may display the information about “entering the initial setting mode for disability assistance” displayed with the first UI 320 in various languages, such as Korean, English, Japanese, Chinese, and the like, and may display the information in a font size larger than a threshold size so as to be visually readable by a user with visual impairment.

The processor 140 may control the speaker 120 to output a guide voice corresponding to the first UI 320. Here, the guiding voice corresponding to the first UI 320 may be a voice that guides a user to enter the initial setting mode for disability assistance.

The processor 140 may control the display 110 to display a figure in the form of the speaker 120 indicating that the guide voice corresponding to the first UI 320 is being output together with the first UI 320 in one area of the screen 310 regarding the initial setting mode.

FIG. 3C is a view provided to explain usage information guidance of remote control buttons provided in an initial setting mode for disability assistance of an electronic device according to an embodiment.

Referring to FIG. 3C, the processor 140 may control the display 110 to display a GUI 330 for usage information for the remote control buttons to enter the initial setting mode for disability assistance in one area of the screen 310 regarding the initial setting mode.

The processor 140 may control the display 110 to display usage information guidance of the remote control buttons including a remote control manipulation method to enter the initial setting mode for disability assistance together with the GUI 330 for usage information for the remote control buttons in one area of the screen 310 regarding the initial setting mode.

For example, the processor 140 may control the display 110 to display the phrase “Long-press the left long button” in one area of the screen 310 regarding the initial setting mode.

Further, the processor 140 may control the display 110 to highlight and display a direction key button 330-1 from among remote control buttons and display usage information for the remote control buttons, which guides the user through the manipulation method to enter the initial setting mode for disability assistance. The processor 140 may highlight and display the portion of a right direction key 330-1 of the GUI that guides the usage information for the remote control buttons as a manipulation for entering the initial setting mode for disability assistance by highlighting the outline as shown in FIG. 3C.

In addition, the processor 140 may highlight and display the outline of the portion of a volume control button 330-2 of the GUI that guides the usage information for the remote control buttons as a manipulation for entering the initial setting mode for disability assistance.

Here, the processor 140 may control the display 110 to apply zoom-in, blinking effect, color, etc. in addition to highlighting the outline of the directional key 330-1 or the volume control button 330-2 in order to emphasize the directional key 330-1 or the volume control button 330-2 of the GUI that guides the usage information for the remote control buttons.

The processor 140 may control the speaker 120 to output a voice guiding the highlighted button.

In addition, the processor 140 may perform communication with the remote controller through a communication interface to control the display 110 to display a GUI with visual effects (e.g., applying a highlight on an outline of a portion, zoom-in, blinking effect, a color, etc.) to show which button the user has manipulated based on a received signal.

Accordingly, a user with visual or hearing impairments can be guided through the initial setting mode, either through the GUI or by a voice, regarding how to manipulate the remote control buttons, facilitating entering the initial setting mode for disability assistance.

Further, the processor 140 may control the display 110 to display the GUI 330 for the usage information for the remote control buttons along with a UI (e.g., a window closing UI, an X-shaped UI, etc.) that prevents the GUI 330 for the usage information for the remote control buttons from being displayed.

Accordingly, when the user no longer uses the guidance information for the remote controller, the GUI 330 for the usage information for the remote control buttons can be prevented from being displayed through a UI that prevents the GUI 330 for the usage information for the remote control buttons from being displayed.

Such usage information guidance of the remote control buttons as described above is not necessarily displayed alone on the screen of the display 110, and the processor 140 may control the display 110 to display the GUI for the usage information for the remote control buttons together with other UIs. FIG. 3D is a view provided to explain a screen that provides usage information for remote control buttons provided in an initial setting mode for disability assistance of an electronic device according to an embodiment.

Referring to FIG. 3D, the display 110 may be controlled to display the first GUI 320 that guides the initial setting mode for disability assistance in one area of the screen 310 regarding the initial setting mode, and the GUI 330 for the usage information for the remote control buttons in another area of the screen 310 regarding the initial setting mode.

As such, the UIs and the usage information for the remote control buttons may be displayed on the screen simultaneously, facilitating entering the initial setting mode for disability assistance.

The GUI 330 for the usage information for the remote control buttons as described above may be displayed together with other UIs after entering the initial setting mode for disability assistance. In other words, the processor 140 may control the display 110 to display the GUI 330 for the usage information for the remote control buttons together with other UIs for menu selection by the user and for providing guidance information to the user.

The processor 140 may control the speaker 120 to output a guide voice corresponding to the GUI 330 for the usage information for the remote control buttons. Here, the guide voice corresponding to the GUI 330 for the usage information for the remote control buttons may be a guide voice regarding how to manipulate the remote control buttons.

The processor 140 may control the display 110 to display a figure in the form of the speaker 120 indicating that the guide voice corresponding to the UI 330 for the usage information for the remote control buttons is being output together with the UI 330 in one area of the screen 310 regarding the initial setting mode.

The processor 140 may control the display 110 to sequentially display the first UI 320 that guides the initial setting mode for disability assistance for a preset amount of time and then, the GUI 330 for the usage information for the remote control buttons in the same area.

However, the present disclosure is not limited thereto, and the processor 140 may control the display 110 to simultaneously display the first UI 320 that guides the initial setting mode for disability assistance and the GUI 330 for the usage information for the remote control buttons in one area of the screen 310 regarding the initial setting mode.

As such, the processor 140 may control the display 110 to output a screen guiding how to enter the initial setting mode for disability assistance, and control the speaker 120 to output a voice guiding how to enter the initial setting mode for disability assistance.

When the initial setting mode for disability assistance is selected through the first UI 320, the processor 140 may control at least one of the display 110 or the speaker 120 to provide an accessibility menu including a plurality of accessibility functions corresponding to the disability type of the user.

Further, the processor 140 may acquire information about the user's voice detected through the microphone 150 to identify the user's voice command included in the acquired voice. The processor 140 may control the electronic device 100 to execute the initial setting mode for disability assistance based on the identified user's voice command. The processor 140 may control at least one of the display 110 or the speaker 120 to provide an accessibility menu including a plurality of accessibility functions corresponding to the disability type of the user based on the identified user's voice command.

Accordingly, starting from the step of initiating the initial setting mode, the processor 140 may control the operation of the initial setting mode for disability assistance based on the user's voice command detected through the microphone 150, allowing the user with a disability to utilize the initial setting mode for disability assistance more conveniently.

In one example, a visually impaired person can enter the accessibility menu by following the guidance provided in the initial setup mode for disability assistance (e.g., remote control guidance), and enter the accessibility menu to select his or her disability type.

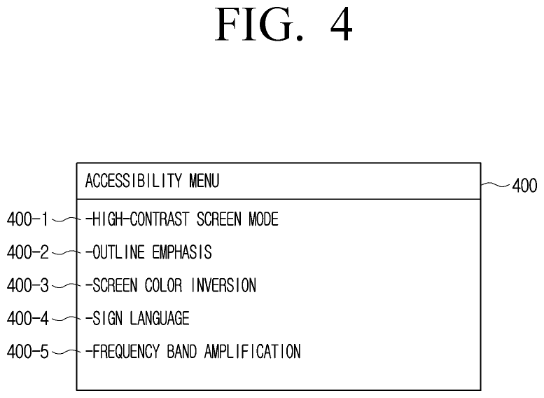

FIG. 4 is a view provided to explain an accessibility menu including a plurality of accessibility functions for disability assistance displayed by the electronic device 100 according to an embodiment.

Referring to FIG. 4, the processor 140 may control at least one of the display 110 or the speaker 120 to provide an accessibility menu 400 including a menu for a plurality of accessibility functions that correspond to visual or hearing impairment of the user, such as a high-contrast screen mode 400-1, an outline emphasis 400-2, a screen color inversion 400-3, a sign language 400-4, and a frequency band amplification 400-5.

Further, the processor 140 may control at least one of the display 110 or the speaker 120 to provide the GUI 330 for the usage information for the remote control buttons that guides the user's manipulation of the remote control buttons together with the accessibility menu 400. The processor 140 may control the display 110 to highlight and display the buttons that can be manipulated by the user (e.g., highlighting an outline, enlarging a button, displaying a blinking effect, applying a color, etc.) together with the GUI 330 for the usage information for the remote control buttons, and control the speaker 120 to output a voice guiding the highlighted buttons.

In addition, since there may be a case in which the user may not use guidance information for the remote controller, the processor 140 may control the display 110 to display the GUI 330 for the usage information for the remote control buttons together with a UI (e.g., a window closing UI, an X-shaped UI, etc.) that prevents the GUI 330 for the usage information for the remote control buttons from being displayed.

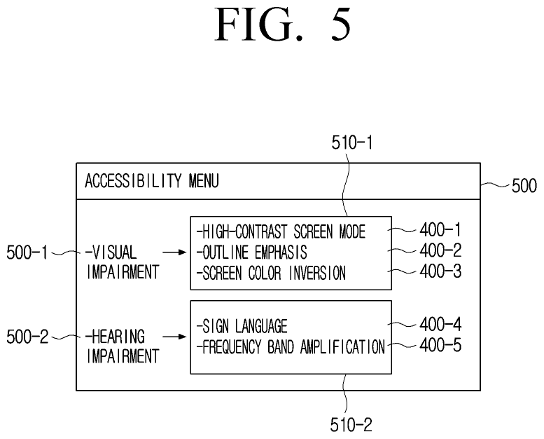

FIG. 5 is a view provided to explain an accessibility menu including a plurality of accessibility functions for disability assistance displayed by the electronic device 100 according to an embodiment.

Referring to FIG. 5, when the initial setting mode for disability assistance is selected, the processor 140 may control the display 110 to display a second UI 500 for identifying the user's disability type 500-1, 500-2. The processor 140 may control the display 110 to display information indicating the user's disability type 500-1, 500-2 in the second UI 500, such as information about the visual impairment 500-1 and information about the hearing impairment 500-2.

Here, the processor 140 may control the display 110 to display information about a question for identifying the user's disability type 500-1, 500-2 together with the second UI 500. Here, the question for identifying the user's disability type 500-1, 500-2 may include content about the nature of the user's disability, such as “Do you have blurred vision?”, “Are you color blind?”, “Do you have astigmatism?”, “Do you have hearing loss?”, etc.

Further, the processor 140 may control the speaker 120 to output a voice corresponding to the second UI 500 for identifying the user's disability type 500-1, 500-2. Here, the voice corresponding to the second UI 500 may be a voice regarding information indicating the user's disability type 500-1, 500-2, such as information about the visual impairment 500-1, information about the hearing impairment 500-2, or a voice regarding a question for identifying the user's disability type 500-1, 500-2.

The processor 140 may receive a user input through the user interface 170 or receive a signal regarding a user input received from a user terminal device such as a remote controller through the communication interface 180 to identify the user's disability type 500-1, 500-2.

In addition, the processor 140 may identify the user's disability type by receiving an input regarding a response to the question for identifying the user's disability type 500-1, 500-2 through the user interface 170 or receiving a signal regarding a response to the question for identifying the disability type 500-1, 500-2 received from a user terminal device such as a remote controller through the communication interface 180.

When the user's disability type 500-1, 500-2 is identified, the processor 140 may control the display 110 to display a menu for accessibility functions 400-1, 400-2, 400-3, 400-4, 400-5 corresponding to the identified disability type, as shown in FIG. 5. Here, the processor 140 may control the display 110 to display the menu for the accessibility functions 400-1, 400-2, 400-3, 400-4, 400-5 corresponding to the identified disability type in a separate UI 510-1, 510-2 that is different from the second UI 500 for identifying the user's disability type 500-1, 500-2.

Further, the processor 140 may control the speaker 120 to output a voice guiding the menu for the accessibility functions 400-1, 400-2, 400-3, 400-4, 400-5 corresponding to the identified disability type.

The accessibility menu including the plurality of accessibility functions 400-1, 400-2, 400-3, 400-4, 400-5 may be provided to the user as shown in the embodiment of FIG. 5 described above, but is not limited thereto.

When the initial setting mode for disability assistance is selected, the processor 140 may control the display 110 to display a third UI (which may be displayed as shown in FIG. 4) corresponding to the accessibility menu including the plurality of accessibility functions 400-1, 400-2, 400-3, 400-4, 400-5, and when the user's disability type 500-1, 500-2 is identified as visual impairment 500-1 based on a user input or a signal received from a user terminal device, the processor 140 may control the display 110 to display a fourth UI including a menu for at least one accessibility function 400-1, 400-2, 400-3 corresponding to the type of visual impairment 500-1 from among the plurality of accessibility functions 400-1, 400-2, 400-3, 400-4, 400-5, separately from the third UI.

In other words, the processor 140 may control the display 110 to select the accessibility functions 400-1, 400-2, 400-3 that correspond to the user's disability type 500-1, 500-2 from among the plurality of accessibility functions 400-1, 400-2, 400-3, 400-4, 400-5 included in the accessibility menu displayed as the third UI on the display 110 and display the same as the separate fourth UI.

The processor 140 may receive a user input of selecting at least one accessibility function from among the plurality of accessibility functions 400-1, 400-2, 400-3, 400-4, 400-5 included in the accessibility menu through the user interface 170 or perform a communication connection with a user terminal device through the communication interface 180 to receive a signal regarding a user input of selecting at least one accessibility function from among the plurality of accessibility functions 400-1, 400-2, 400-3, 400-4, 400-5 included in the accessibility menu.

When at least one accessibility function is selected from the accessibility menu, the processor 140 may control at least one of the display 110 or the speaker 120 based on the at least one accessibility function.

When the user's disability type is identified as visual impairment 500-1, the processor 140 may control at least one of the display 110 or the speaker 120 to provide a menu for accessibility functions including at least one of a high-contrast output function 400-1, an outline emphasis function 400-2, or a screen color inversion output function 400-3. When at least one of the menus for the accessibility functions 400-1, 400-2, 400-3, 400-4, 400-5 is selected, the processor 140 may control the display 110 to output a screen to which the selected accessibility function applied.

Further, when at least one of the menus for the accessibility function 400-1, 400-2, 400-3, 400-4, 400-5 is selected, the processor 140 may control at least one of the display 110 or the speaker 120 to provide an initial setting mode with the selected accessibility function applied.

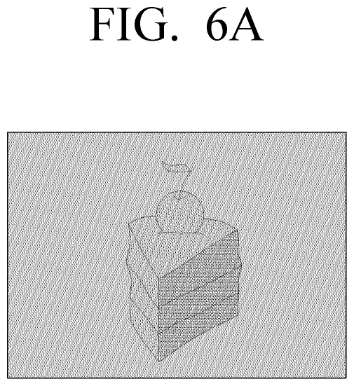

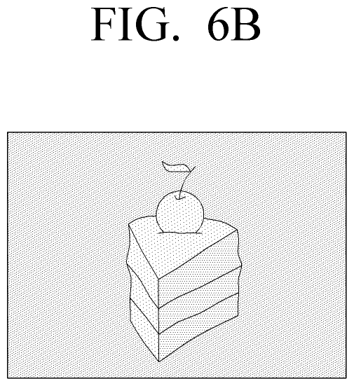

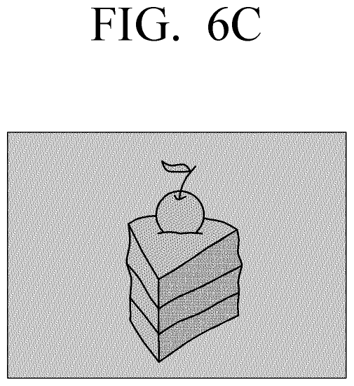

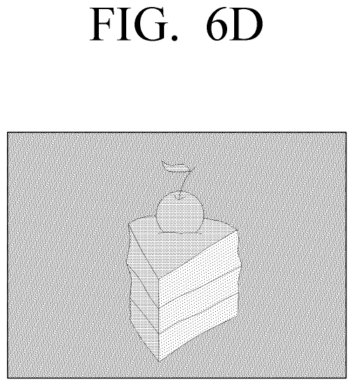

A screen with the high-contrast output function 400-1, the outline emphasis function 400-2, or the color inversion output function 400-3 applied will be described with reference to FIG. 6.

FIG. 6A is a view provided to explain a screen displayed by the electronic device 100 according to an embodiment.

Referring to FIG. 6A, when the contrast between light and dark areas of an image displayed on the display 110 is not large, a user may have difficulty clearly recognizing the image displayed on the display 110.

FIG. 6B is a view provided to explain a screen to which a high-contrast output function from among a plurality of accessibility functions is applied according to an embodiment.

Referring to FIG. 6B, when the high-contrast output function 400-1 is applied, the processor 140 may control the display 110 to display a screen in which the brightness contrast between the light and dark areas of the original image is equal to or greater than a preset value. Accordingly, a user with low vision due to visual impairment may recognize the image displayed on the display 110 more clearly.

FIG. 6C is a view provided to explain a screen to which an outline emphasis function from among a plurality of accessibility functions is applied according to an embodiment.

Referring to FIG. 6C, when the outline emphasis function 400-2 is applied, the processor 140 may control the display 110 to identify the outline of an object included in the original image and display the outline with a thickness greater than a preset value. Accordingly, a user with low vision due to visual impairment may recognize the outline of the object included in the image displayed on the display 110 more clearly.

FIG. 6D is a view provided to explain a screen to which a color inversion output function from among a plurality of accessibility functions is applied according to an embodiment.

Referring to FIG. 6D, when the color inversion output function 400-3 is applied, the processor 140 may control the display 110 to output a screen in which at least one color forming the original image is inverted to a complementary color corresponding to the color. Accordingly, a user with visual impairment who has difficulty recognizing a certain color may recognize the image more clearly through the screen with the color inversion function applied.

When the user's disability type is identified as hearing impairment 500-2, the processor 140 may control at least one of the display 110 or the speaker 120 to provide a menu for accessibility functions including at least one of a sign language function 400-4 or a frequency band amplification function 400-5. The processor 140 may control at least one of the display 110 or the speaker 120 to output a screen or a voice with the accessibility functions 400-4, 400-5 applied corresponding to the hearing impairment 500-2 based on a user input received through the user interface 170 or a signal regarding a user input received from a user terminal device through the communication interface 180.

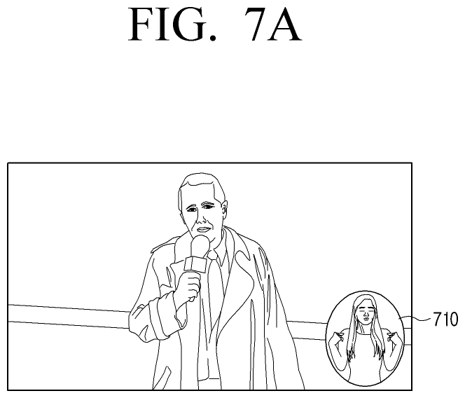

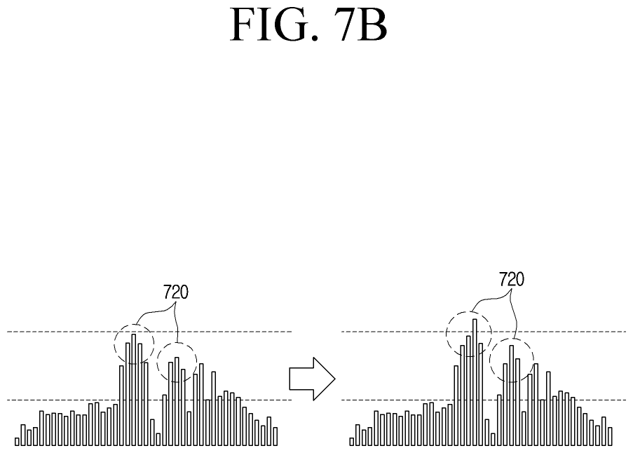

The sign language function 400-4 or the frequency band amplification function 400-5 will be described with reference to FIG. 7.

FIG. 7A is a view provided to explain a screen to which a sign language function from among a plurality of accessibility functions is applied according to an embodiment.

Referring to FIG. 7A, the processor 140 may control the display 110 to display a UI 710 representing a sign language corresponding to a voice output through the speaker 120 of the electronic device 100 on one area of the screen of the display 110. Accordingly, a user with hearing impairment may visually recognize the content of the voice output through the speaker 120 through the UI 710 representing the sign language displayed on the display 110, even if the user does not hear the voice.

FIG. 7B is a view provided to explain a frequency band amplification function from among a plurality of accessibility functions is applied according to an embodiment.

Referring to FIG. 7B, the processor 140 may control the speaker 120 to amplify and output a frequency band 720 in a voice output through the speaker 120 of the electronic device 100. Accordingly, a user with hearing impairment may hear the amplified frequency band 720 of voice and recognize the content of the voice output through the speaker 120.

As described above, the processor 140 may control the display 110 to display a screen to which at least one accessibility function selected by the user input from among the plurality of accessibility functions 400-1, 400-2, 400-3, 400-4, 400-5 is applied, or control the speaker 120 to output a voice to which at least one accessibility function is applied.

In addition, the processor 140 may control at least one of the display 110 or the speaker 120 to provide the user with usage information for the buttons included in the remote controller.

When the initial setting mode is initiated and the initial setting mode for disability assistance is selected, the processor 140 may control the display 110 to display a GUI 800 corresponding to the remote controller based on a visual GUI corresponding to the visual impairment.

Here, the GUI 800 corresponding to the remote controller displayed based on the visual GUI may be a GUI with at least one of the high-contrast output function 400-1, the outline emphasis function 400-2, or the color inversion output function 400-3 applied.

The processor 140 may control the display 110 to display usage information for at least one button included in the remote controller through the GUI 800 corresponding to the remote controller, or may control the speaker 120 to output a guide voice corresponding to the usage information for the at least one button included in the remote controller.

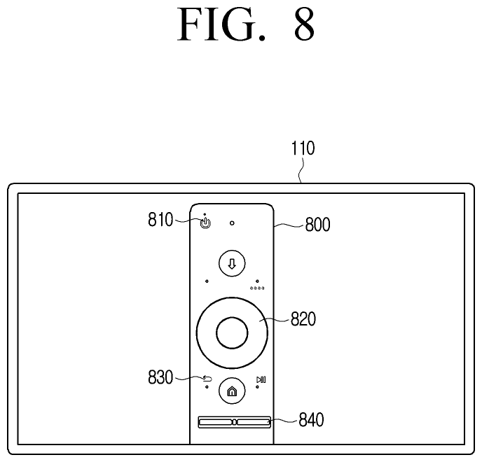

FIG. 8 is a view provided to explain a GUI for describing usage information for buttons included in a remote controller according to another embodiment.

Referring to FIG. 8, the GUI 800 corresponding to the remote controller may include usage information for a power button 810, usage information for an arrow button 820, usage information for a back button 830, and usage information for a volume control button 840.

The processor 140 may control the display 110 to display the GUI 800 corresponding to the remote controller while controlling the speaker 120 to audibly output the usage information for the power button 810, the usage information for the arrow button 820, the usage information for the back button 830, and the usage information for the volume control button 840 included in the GUI 800 corresponding to the remote controller.

Accordingly, a user with visual or hearing impairment can learn how to use the remote controller through the GUI 800 corresponding to the remote controller, the usage information for at least one button included in the remote controller, or the guide voice corresponding to the usage information.

As described above, the processor 140 of the electronic device 100 according to the present disclosure may perform a communication connection with a remote controller through the communication interface 180 to receive a signal regarding a user input from the remote controller, and control configurations of the electronic device 100, such as the display 110, the speaker 120, based on the received signal.

However, this is only one embodiment, and the processor 140 may also perform a communication connection with an external user terminal device such as a smartphone through the communication interface 180 to receive a signal regarding a user input.

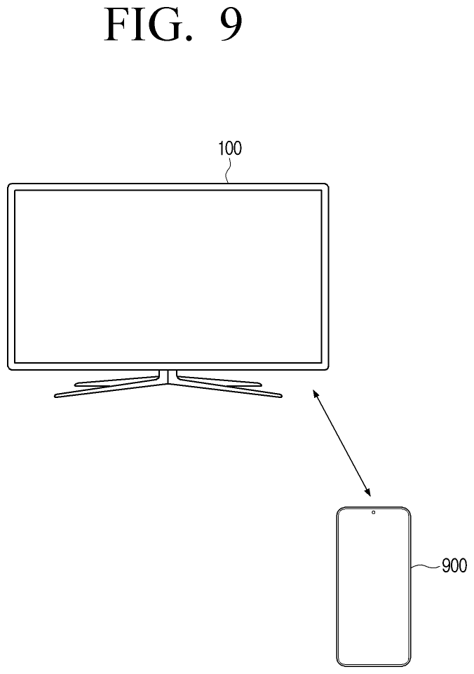

FIG. 9 is a view provided to explain an operation of controlling a selection of a menu provided in an initial setting mode based on a signal corresponding to a user command received through an external user terminal device according to an embodiment.

The processor 140 may perform a Bluetooth (BT) communication connection with an external user terminal device 900 through the communication interface 180 to transmit/receive signals to/from the external user terminal device 900 regarding controlling the operation of the electronic device 100, such as controlling the display 110, controlling the speaker 120, controlling a UI selection, and the like.

The processor 140 may control the speaker 120 to audibly output information about an accessibility menu including a plurality of accessibility functions displayed on the display 110 of the electronic device 100 or the display of the external user terminal device 900. Accordingly, a user with visual impairment may use the initial setting mode for disability assistance using the external user terminal device 900.

The processor 140 may perform the operation of controlling the configurations of the electronic device 100, such as the display 110, the speaker 120, and the like, based on a signal regarding controlling the operation of the electronic device 100 received from the external user terminal device 900 through the communication interface 180.

Here, the processor 140 and the external user terminal device 900 are not limited to performing the communication connection through the communication interface 180 in a BT communication manner, but may also perform the communication connection in a variety of other wireless communication methods such as Wi-Fi.

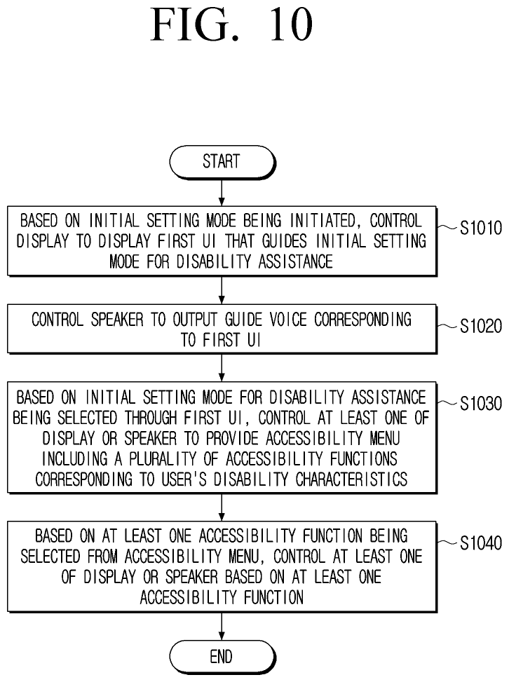

FIG. 10 is a flowchart provided to explain an operation of the electronic device 100 according to an embodiment.

Referring to FIG. 10, when the initial setting mode of the electronic device 100 is initiated, the electronic device 100 may control the display 110 to display a first UI that guides the initial setting mode for disability assistance (S1010).

The electronic device 100 may control the speaker 120 to output a guide voice corresponding to the first UI (S1020).

When the initial setting mode for disability assistance is selected through the first UI, the electronic device 100 may control at least one of the display 110 or the speaker 120 to provide an accessibility menu including a plurality of accessibility functions corresponding to the user's disability type (S1030).

Here, when the initial setting mode for disability assistance is selected, the electronic device 100 may control the display 110 to display a second UI for identifying the user's disability type, and may control the speaker 120 to output a guide voice corresponding to the second UI. The second UI may also include a question for identifying the user's disability type.

In addition, when the initial setting mode for disability assistance is selected, the electronic device 100 may control the display 110 to display a third UI corresponding to an accessibility menu including a plurality of accessibility functions.

Here, the accessibility functions may be a high-contrast output function, a outline emphasis function, a color inversion output function, a sign language function, or a frequency band amplification function.

When the user's disability type is identified, the electronic device 100 may provide a menu for accessibility functions corresponding to the user's disability type. Further, when the user's disability type is identified as visual impairment, the electronic device 100 may control the display 110 to display a fourth UI including a menu for at least one accessibility function corresponding to the visual impairment type from among the plurality of accessibility functions, separately from the third UI.

When at least one accessibility function is selected from the accessibility menu, the electronic device 100 may control at least one of the display 110 or the speaker 120 based on the at least one accessibility function (S1040).

According to an embodiment, the methods according to the various embodiments disclosed in this document may be included and provided in a computer program product. The computer program product may be traded as a product between a seller and a purchaser. The computer program product may be traded as a product between a seller and a purchaser. The computer program product can be distributed in the form of a storage medium that is readable by machines (e.g.: a compact disc read only memory (CD-ROM)), or distributed directly on-line (e.g.: download or upload) through an application store (e.g.: PlayStore™), or between two user devices (e.g.: smartphones). In the case of on-line distribution, at least a portion of a computer program product (e.g.: a downloadable app) may be stored in a storage medium readable by machines such as the server of the manufacturer, the server of the application store, or the memory of the relay server at least temporarily, or may be generated temporarily.

Hereinabove, the embodiments of the disclosure have been described, but the disclosure is not limited to the embodiments, may be variously modified by a person skilled in the art to which the disclosure pertains without departing from the gist of the disclosure as claimed herein, and such modifications should not be individually understood from technical concepts or prospects of the disclosure.

What is claimed is:

1. An electronic device, comprising:
a display;
a speaker;
one or more processors; and
memory storing instructions that, when executed by the one or more processors, cause the electronic device to:
based on an initial setting mode being initiated, control the display to display a first user interface (UI) for guiding a user as to a first initial setting mode for disability assistance;
control the speaker to output a first guide voice corresponding to the first UI;
based on the first initial setting mode for disability assistance being selected through the first UI, control at least one of the display or the speaker to provide a first accessibility menu comprising a plurality of accessibility functions corresponding to a disability type of the user; and
based on at least one accessibility function being selected from the first accessibility menu, control at least one of the display or the speaker based on the at least one accessibility function.

2. The electronic device as claimed in claim 1, wherein the one or more processors are configured to execute the instructions to cause the electronic device to:
based on the first initial setting mode for disability assistance being selected, control the display to display a second UI for identifying the disability type of the user;
control the speaker to output a second guide voice corresponding to the second UI; and
based on the disability type of the user being identified, control at least one of the display or the speaker to provide a second menu for a second accessibility function corresponding to the disability type of the user.

3. The electronic device as claimed in claim 2, wherein the second UI comprises a question for identifying the disability type of the user.

4. The electronic device as claimed in claim 2, wherein the one or more processors are configured to execute the instructions to cause the electronic device to:
based on the first initial setting mode for disability assistance being selected, control the display to display a third UI corresponding to a third accessibility menu comprising the plurality of accessibility functions; and
based on the disability type of the user being identified as a visual impairment, control the display to display a fourth UI comprising a third menu for at least one third accessibility function corresponding to the visual impairment from among the plurality of accessibility functions separately from the third UI.

5. The electronic device as claimed in claim 2, wherein the one or more processors are configured to execute the instructions to cause the electronic device to, based on the disability type of the user being identified as a visual impairment, control at least one of the display or the speaker to provide a third menu for a third accessibility function comprising at least one of a high-contrast output function, an outline emphasis function, or a color inversion output function.

6. The electronic device as claimed in claim 5, wherein the one or more processors are configured to execute the instructions to cause the electronic device to, based on at least one menu for the at least one accessibility function being selected, control the display to output a screen to which the selected at least one accessibility function is applied.

7. The electronic device as claimed in claim 2, wherein the one or more processors are configured to execute the instructions to cause the electronic device to, based on the disability type of the user being identified as a hearing impairment, control at least one of the display or the speaker to provide a third menu for a third accessibility function comprising at least one of a sign language function or a frequency band amplification function.

8. The electronic device as claimed in claim 1, wherein the one or more processors are configured to execute the instructions to cause the electronic device to:
based on the first initial setting mode for disability assistance being selected, control the display to display a GUI corresponding to a remote controller based on a visual GUI corresponding to a visual impairment;
control the display to display usage information for at least one button included in the remote controller; and
control the speaker to output a second guide voice corresponding to the usage information.

9. The electronic device as claimed in claim 1, further comprising:
a communication interface,
wherein the one or more processors are configured to execute the instructions to cause the electronic device to, while an application corresponding to the first initial setting mode is executed in an external user terminal, based on a received signal corresponding to a user command received through an execution screen of the application being obtained, control a selection of a second menu provided in the first initial setting mode based on the received signal.

10. A control method of an electronic device, comprising:
based on an initial setting mode being initiated, displaying a first user interface (UI) for guiding a user as to a first initial setting mode for disability assistance;
outputting a first guide voice corresponding to the first UI;
based on the first initial setting mode for disability assistance being selected through the first UI, providing a first accessibility menu comprising a plurality of accessibility functions corresponding to a disability type of the user; and
based on at least one accessibility function being selected from the first accessibility menu, controlling the electronic device based on the at least one accessibility function.

11. The control method as claimed in claim 10, wherein the providing the first accessibility menu comprises:
based on the first initial setting mode for disability assistance being selected, displaying a second UI for identifying the disability type of the user;
outputting a second guide voice corresponding to the second UI; and
based on the disability type of the user being identified, providing a second menu for a second accessibility function corresponding to the disability type of the user.

12. The control method as claimed in claim 11, wherein the second UI comprises a question for identifying the disability type of the user.

13. The control method as claimed in claim 11, wherein the providing the first accessibility menu comprises:
based on the first initial setting mode for disability assistance being selected, displaying a third UI corresponding to a third accessibility menu comprising the plurality of accessibility functions; and
based on the disability type of the user being identified as visual impairment, displaying a fourth UI comprising a third menu for at least one second accessibility function corresponding to the visual impairment from among the plurality of accessibility functions separately from the third UI.

14. The control method as claimed in claim 11, wherein the providing the first accessibility menu comprises, based on the disability type of the user being identified as a visual impairment, providing a third menu for a third accessibility function comprising at least one of a high-contrast output function, an outline emphasis function, or a color inversion output function.

15. The control method as claimed in claim 14, wherein the providing the first accessibility comprises, based on at least one menu for the at least one accessibility function being selected, outputting a screen to which the selected at least one accessibility function is applied.

16. The control method as claimed in claim 11, wherein the providing the first accessibility menu comprises, based on the disability type of the user being identified as a hearing impairment, providing a third menu for a third accessibility function comprising at least one of a sign language function or a frequency band amplification function.

17. The control method as claimed in claim 10, wherein the control method further comprises, based on the first initial setting mode for disability assistance being selected, displaying a GUI corresponding to a remote controller based on a visual GUI corresponding to a visual impairment, displaying usage information for at least one button included in the remote controller, and outputting a second guide voice corresponding to the usage information.

18. The control method as claimed in claim 10, wherein the electronic device further comprises a communication interface, and the control method further comprises, while an application corresponding to the first initial setting mode is executed in an external user terminal, based on a received signal corresponding to a user command received through an execution screen of the application being obtained, controlling a selection of a second menu provided in the first initial setting mode based on the received signal.

19. A non-transitory computer-readable recording medium having instructions recorded thereon, that, when executed by one or more processors, cause the one or more processors to:
based on an initial setting mode being initiated, displaying a first UI that guides a first initial setting mode for disability assistance;
outputting a guide voice corresponding to the first UI;
based on the first initial setting mode for disability assistance being selected through the first UI, providing an accessibility menu comprising a plurality of accessibility functions corresponding to a disability type of a user; and
based on at least one accessibility function being selected from the accessibility menu, controlling the electronic device based on the at least one accessibility function.
